(19) United States
(12) Patent Application Publication
(10) Pub. No.: US 2020/0372873 A1
(43) Pub. Date: Nov. 26, 2020

(54) GATE DRIVE UNIT CIRCUIT, GATE DRIVE CIRCUIT, AND DISPLAY DEVICE

(71) Applicants: Nanjing CEC Panda FPD Technology Co., Ltd., Nanjing, Jiangsu (CN); Nanjing CEC Panda LCD Technology Co., Ltd., Nanjing, Jiangsu (CN)

(72) Inventors: Hongtao HUANG, Nanjing, Jiangsu (CN); Chao DAI, Nanjing, Jiangsu (CN)

(21) Appl. No.: 16/957,960

(22) PCT Filed: Dec. 20, 2018
(86) PCT No.: PCT/CN2018/122431

§ 371 Date: Jun. 25, 2020

(30) Foreign Application Priority Data
Dec. 27, 2017 (CN) 201711440299.2

(51) Int. Cl. G09G 3/36

(52) U.S. Cl. CPC G09G 3/3677

(57) ABSTRACT

A gate drive unit circuit, a gate drive circuit, and a display device. The gate drive unit circuit comprises a pull-up control module (1), a pull-up module (2), a pull-down module (3), a hold control node generation module (4), a pull-up control node hold module (5), and an output node hold module (6). When the gate drive unit circuit is not a first-stage or last-stage gate drive unit circuit, the pull-up control node hold module (5) is connected to a previous-stage hold control node of the hold control node generation module (4) of the gate drive unit circuit of a previous stage and to a following-stage hold control node of the hold control node generation module (4) of the gate drive unit circuit of a following stage. A pull-up control node in the current stage is held under the control of the previous-stage hold control node and the following-stage hold control node. The invention prevents the problem in which, when a scanning direction is switched, a thin film transistor experiences a bias stress, which produces a threshold voltage drift, which in turn causes a circuit function failure. Thus, circuit reliability is improved.

### TECHNICAL FIELD

The present invention relates to the field of liquid crystal display, and in particular to a gate driving unit circuit, a gate driving circuit, and a display apparatus.

### TECHNICAL BACKGROUND

An integrated gate scanning driving circuit (Gate Driver Monolithic, GDM) is a technology in which a gate scanning driving circuit is directly constructed on an array substrate by using an existing manufacturing process of a thin film transistor array substrate, and has a function of reducing costs, reducing process procedures, and reducing width of a panel frame. With the development of products and technologies, a flat panel display has increasingly high requirements for a gate scanning driving circuit, one of which is to have both a forward scanning function and a backward scanning function.

FIG. 1 is a schematic circuit diagram of a gate driving unit circuit that has a forward and backward scanning function. The gate driving unit circuit includes a pull-up control module 1, a pull-up module 2, a holding control node generation module 4, a pull-up control node holding module 5, an output node holding module 6, a clearing module 7, an auxiliary holding module 8, and a bootstrap capacitor C1 that control the forward and backward scanning. Both the pull-up control module 1 and the holding control node generation module 4 are controlled by signals in a previous stage and a following stage gate driving unit circuits, with symmetry. The thin film transistors M1 and M9 in the pull-up control module 1 are symmetric, and the thin film transistors M5 and M7 in the holding control node generation module 4 are symmetric.

A scanning direction of the gate driving unit circuit is controlled by using a pair of constant voltage signals mutually opposite in phase, namely a forward scanning control signal U2D and a backward scanning control signal D2U, where a forward scanning is performed when U2D is at a high level and D2U is at a low level, and a backward scanning is performed when reversed.

However, because the U2D and the D2U are mutually opposite in phase, the two thin film transistors M5 and M7 in the holding control node generation module 4 are subjected to biasing stress with opposite symbols for a long time, so as to generate a threshold voltage drift with opposite directions. After the scanning direction is switched, the holding capability of the pull-up control node holding module 5 is reduced, circuit reliability is reduced, and circuit complexity is also increased.

### SUMMARY OF THE INVENTION

To resolve the foregoing technical problems, the present invention provides a gate driving unit circuit, a gate driving circuit, and a display apparatus, which can avoid the problem that a thin film transistor in a holding control node generation module is subjected to biasing stress to generate a threshold voltage, and can hold a pull-up control node at any time, thereby improving circuit reliability.

According to a first aspect of the present invention, a gate driving unit circuit is provided, adapted for multi-stage connection to form a gate driving circuit, characterized in comprising a pull-up control module, a pull-up module, a pull-down module, a holding control node generation module, a pull-up control node holding module, and an output node holding module, wherein the pull-up control module, the pull-up module, the holding control node generation module, and the pull-up control node holding module are connected to a current stage pull-up control node, the pull-up module and the output node holding module are connected to a current stage scanning signal line;

wherein, when the gate driving unit circuit is not a first-stage gate driving unit circuit or a last-stage gate driving unit circuit, the pull-up control node holding module is connected to a previous stage holding control node of the holding control node generation module of a previous stage gate driving unit circuit and a following stage holding control node of the holding control node generation module of a following stage gate driving unit circuit, and holds the current stage pull-up control node under control of the previous stage holding control node and the following stage holding control node;
when the gate driving unit circuit is the first-stage gate driving unit circuit, the pull-up control node holding module is connected to a last-stage clock signal and the following stage holding control node of the holding control node generation module of the following stage gate driving unit circuit, and holds the current stage pull-up control node under control of the last-stage clock signal and the following stage holding control node; and
when the gate driving unit circuit is the last-stage gate driving unit circuit, the pull-up control node holding module is connected to a first-stage clock signal and the previous stage holding control node of the holding control node generation module of the previous stage gate driving unit circuit, and holds the current stage pull-up control node under control of the first-stage clock signal and the previous stage holding control node.

According to a preferred embodiment of the invention, wherein the holding control node generation module comprises a fifth thin film transistor, a sixth thin film transistor, and a seventh thin film transistor;

the fifth thin film transistor is configured to charge the current stage holding control node, a first path end of the fifth thin film transistor is connected to the current stage holding control node, and a control end and a second path end thereof input a first clock signal; and
the sixth thin film transistor is configured to prohibit the output of the current stage holding control node during operation of the current stage gate driving unit circuit, where a control end of the sixth thin film transistor is connected to the current stage up-pull control node, a first path end is connected to a low level, and a second path end is connected to the current stage holding control node; and
the seventh thin film transistor is configured to discharge the current stage holding control node, a control end of the seventh thin film transistor is input a second clock signal, a first path end is connected to a low level, and a second path end is connected to the current stage holding control node.

According to a preferred embodiment of the invention, wherein the holding control node generation module comprises a fifth thin film transistor, a sixth thin film transistor, and a seventh thin film transistor;

the fifth thin film transistor is configured to charge the current stage holding control node, a control end of the fifth thin film transistor is input a first clock signal, a first path end is connected to the current stage holding control node, and a second path end is connected to a high level;
the sixth thin film transistor is configured to prohibit the output of the current stage holding control node during operation of the current stage gate driving unit circuit, where a control end of the sixth thin film transistor is connected to the current stage up-pull control node, a first path end is connected to a low level, and a second path end is connected to the current stage holding control node; and
the seventh thin film transistor is configured to discharge the current stage holding control node, a control end of the seventh thin film transistor is input a second clock signal, a first path end is connected to a low level, and a second path end is connected to the current stage holding control node.

According to a preferred embodiment of the invention, wherein the pull-up control node holding module comprises an eighth thin film transistor and an eighteenth thin film transistor; a control end of the eighth thin film transistor is connected to the previous stage holding control node, a first path end is connected to a low level, and a second path end is connected to a current stage pull-up control node; wherein the control end of the eighth thin film transistor of the first-stage gate driving unit circuit is input a last-stage clock signal;

a control end of the eighteenth thin film transistor is connected to the following stage holding control node, a first path end is connected to a low level, and a second path end is connected to a current stage pull-up control node; wherein the control end of the eighteenth thin film transistor of the first-stage gate driving unit circuit is input a first-stage clock signal.

According to a preferred embodiment of the invention, wherein the pull-up control module comprises a first thin film transistor and a sixteenth thin film transistor;

the first thin film transistor is configured to pre-charge a current stage pull-up control node during a forward scanning, where a control end of the first thin film transistor is connected to a scan signal line of a previous stage gate driving unit circuit, a first path end is connected to the current stage pull-up control node, and a second path end is connected to a high level; wherein the control end of the first thin film transistor of the first-stage gate driving unit circuit is input a forward scanning start signal;
the sixteenth thin film transistor is configured to pre-charge a current stage pull-up control node during backward scanning, where a control end of the sixteenth thin film transistor is connected to a scanning signal line of a following stage gate driving unit circuit, a first path end is connected to the current stage pull-up control node, and a second path end is connected to a high level; the control end of the sixteenth thin film transistor of the last-stage gate driving unit circuit is input a backward scanning start signal.

According to a preferred embodiment of the invention, wherein the circuit further comprises a cascade node generation module; the cascade node generation module includes a thirteenth thin film transistor and a fourteenth thin film transistor; a control end of the thirteenth thin film transistor is connected to a current stage pull-up control node, and a first path end and a second path end thereof are respectively connected to the current cascade node and the first clock signal; and a control end of the fourteenth thin film transistor is connected to a current stage holding control node, and a first path end and a second path end thereof are respectively connected to a low level and a current stage cascade node;

the pull-up control module comprises a first thin film transistor and a sixteenth thin film transistor; a control end of the first thin film transistor is connected to a previous stage cascade node of a previous stage gate driving unit circuit, a first path end is connected to a current stage pull-up control node, and a second path end is connected to a high level; a control end of the sixteenth thin film transistor is connected to a following stage cascade node of the following stage gate driving unit circuit, a first path end is connected to a current stage pull-up control node, and a second path end is connected to a high level.

According to a preferred embodiment of the invention, wherein the output node holding module comprises an eleventh thin film transistor, the eleventh thin film transistor is configured to hold a current stage scanning signal, a control end of the eleventh thin film transistor is connected to a second clock signal, and a first path end and a second path end thereof are respectively connected to a low level and a current stage scanning signal line.

According to a preferred embodiment of the invention, wherein the output node holding module comprises an eleventh thin film transistor, the eleventh thin film transistor is configured to hold a current stage scanning signal, a control end of the eleventh thin film transistor is connected to a holding control node of the current stage, and a first path end and a second path end thereof are respectively connected to a low level and a current stage scanning signal line.

According to a preferred embodiment of the invention, wherein the output node holding module further comprises a nineteenth thin film transistor; a control end of the nineteenth thin film transistor is connected to a current stage holding control node, and a first path end and a second path end thereof are respectively connected to a low level and a current stage scanning signal line.

According to a preferred embodiment of the invention, wherein the output node holding module comprises an eleventh thin film transistor and a nineteenth thin film transistor; and a control end of an eleventh thin film transistor is connected to the previous stage holding control node, and a first path end and a second path end thereof are respectively connected to a low level and a current stage scanning signal line; a control end of the nineteenth thin film transistor is connected to the following stage holding control node, and a first path end and a second path end thereof are respectively connected to a low level and a current stage scanning signal line.

According to a preferred embodiment of the invention, wherein the circuit further comprises a touch control holding module; wherein the touch control holding module comprises a twelfth thin film transistor; a control end of the twelfth thin film transistor is input a touch control signal, and a first path end and a second path end thereof are respectively connected to a low level and a current stage scanning signal line.

According to a preferred embodiment of the invention, wherein the pull-up module comprises a tenth thin film transistor; a control end of the tenth thin film transistor is connected to a current stage pull-up control node, and a first path end and a second path end thereof are respectively connected to a scanning signal line of the current stage and a first clock signal.

According to a preferred embodiment of the invention, wherein the pull-down module comprises a ninth thin film transistor; a control end of the ninth thin film transistor is input a second clock signal, and a first path end and a second path end thereof are respectively connected to a low level and a current stage pull-up control node.

According to a preferred embodiment of the invention, wherein the circuit further comprises an auxiliary holding module; and the auxiliary holding module comprises a fourth thin film transistor and a seventeenth thin film transistor;

a control end of the fourth thin film transistor is input a forward scanning start signal, and a first path end and a second path end thereof are respectively connected to a low level and a current stage pull-up control node; wherein the control end of the fourth thin film transistor of the gate driving unit circuits in the first three stages is input a low level;
a control end of the seventeenth thin film transistor is input a backward scanning start signal, and a first path end and a second path end thereof are respectively connected to a low level and a current stage pull-up control node; wherein the control end of the seventeenth thin film transistor of the gate driving unit circuit in the last three stages is input a low level.

According to a preferred embodiment of the invention, wherein the circuit further comprises a clearing module; the clearing module comprises a second thin film transistor, a third thin film transistor, and a twelfth thin film transistor;

a control end of the second thin film transistor is input a clearing signal, and a first path end and a second path end thereof are respectively connected to a low level and a current stage pull-up control node;
a control end of the third thin film transistor is input a clearing signal, and a first path end and a second path end thereof are respectively connected to a low level and a current stage holding control node; and
a control end of the twelfth thin film transistor is input a clearing signal, and a first path end and a second path end thereof are respectively connected to a low level and a current stage scanning signal line.

According to a preferred embodiment of the invention, wherein the circuit further comprises a clearing module; the clearing module comprises a second thin film transistor, a third thin film transistor, a twelfth thin film transistor, and a fifteenth thin film transistor;

a control end of the second thin film transistor is input a clearing signal, and a first path end and a second path end thereof are respectively connected to a low level and a current stage pull-up control node;
a control end of the third thin film transistor is input a clearing signal, and a first path end and a second path end thereof are respectively connected to a low level and a current stage holding control node;
a control end of the twelfth thin film transistor is input a clearing signal, and a first path end and a second path end thereof are respectively connected to a low level and a current stage scanning signal line; and
a control end of the fifteenth thin film transistor is input a clearing signal, and a first path end and a second path end thereof are respectively connected to a low level and a current stage cascade node.

According to a preferred embodiment of the invention, wherein the circuit further comprises a clearing module; the clearing module comprises a second thin film transistor and a third thin film transistor;

a control end of the second thin film transistor is input a clearing signal, and a first path end and a second path end thereof are respectively connected to a low level and a current stage pull-up control node; and
a control end of the third thin film transistor is input a clearing signal, and a first path end and a second path end thereof are respectively connected to a low level and a current stage holding control node.

According to the second aspect of the invention, a gate driving circuit is provided, comprising N stages of the gate driving unit circuit according to any one of the above embodiments, wherein N is an integer greater than 3; and wherein,

when 2≤n≤N−1, the pull-up control node holding module of the gate driving unit circuit of the nth stage is respectively connected to the holding control node generation module of the gate driving unit circuit of the (n−1)th stage and the holding control node generation module of the gate driving unit circuit of the (n+1)th stage;
when n=1, the pull-up control node holding module of the gate driving unit circuit of the nth stage is input the last-stage clock signal, and is connected to the holding control node generation module of the gate driving unit circuit of the (n+1)th stage;
when n=N, the pull-up control node holding module of the gate driving unit circuit of the nth stage is input the first-stage clock signal, and is connected to the holding control node generation module of the gate driving unit circuit of the (n−1)th stage.

According to the third aspect of the invention, a display apparatus is provided, comprising the gate driving circuit according to any one of the above embodiments.

Compared with the prior art, a holding control node generation module at each stage in the gate driving circuit in the embodiments of the present invention is responsible for controlling the pull-up control node holding modules in the previous and following stages. Similarly, the pull-up control node holding module at the current stage is controlled by the holding control node generation modules at a previous stage and the holding control node generation module at a following stage. The pull-up control node holding module and the holding control node generation module have the same working state in a forward scanning process and a backward scanning process, avoiding the problem that the circuit function is ineffective because a thin film transistor is biased by a voltage stress to cause a threshold voltage drift after a scanning direction is switched, and improving the circuit reliability.

### BRIEF DESCRIPTION OF DRAWINGS

The following further describes the present invention in a clear and understandable manner in combination with the accompanying drawings and preferred embodiments.

FIG. 1 is a schematic circuit diagram of a gate driving unit circuit that has a forward and backward scanning function;

FIG. 2 is a schematic circuit diagram of a gate driving unit circuit and a gate driving circuit formed thereby according to an embodiment of the present invention;

FIG. 3 is a schematic circuit diagram of a gate driving unit circuit according to Embodiment 1 of the present invention;

FIG. 4 is a schematic circuit diagram of a gate driving unit circuit according to Embodiment 2 of the present invention;

FIG. 5 is a schematic circuit diagram of a gate driving unit circuit according to Embodiment 3 of the present invention;

FIG. 6 is a schematic diagram of a driving waveform of the gate driving unit circuit shown in FIG. 5 in a forward scanning;

FIG. 7 is a schematic diagram of a driving waveform of the gate driving unit circuit shown in FIG. 5 in a backward scanning;

FIG. 8 is a schematic circuit diagram of a gate driving unit circuit according to Embodiment 4 of the present invention;

FIG. 9 is a schematic circuit diagram of a gate driving unit circuit according to Embodiment 5 of the present invention;

FIG. 10 is a schematic circuit diagram of a gate driving unit circuit according to Embodiment 6 of the present invention;

FIG. 11 is a schematic circuit diagram of a gate driving unit circuit according to Embodiment 7 of the present invention;

FIG. 12 is a schematic circuit diagram of a gate driving unit circuit according to Embodiment 8 of the present invention;

FIG. 13 is a schematic diagram of a driving waveform of the gate driving unit circuit shown in FIG. 12 in a forward scanning;

FIG. 14 is a schematic diagram of a driving waveform of the gate driving unit circuit shown in FIG. 12 in a backward scanning; and

FIG. 15 is an example diagram of a liquid crystal display apparatus that uses a gate driving circuit according to an embodiment of the present invention.

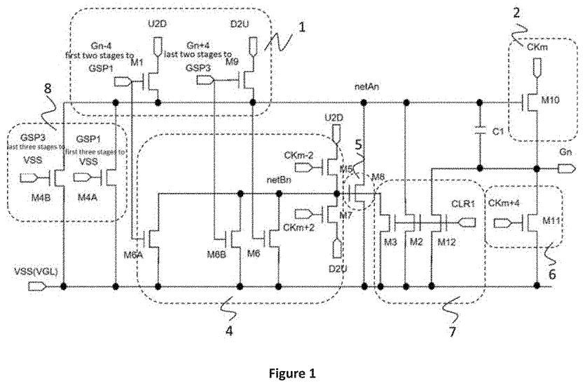

### DESCRIPTION OF REFERENCE NUMERALS IN THE DRAWINGS

1. Pull-up control module, 2. Pull-up module, 3. Pull-down module, 4. Holding control node generation module, 5. Pull-up control node holding module, 6. Output node holding module, 7. Clearing module, 8. Auxiliary holding module, 9. Cascade node generation module, 10. Touch control holding module;

M1A. First thin film transistor, M1B, sixteenth thin film transistor, M2, second thin film transistor, M3, third thin film transistor, M4A, fourth thin film transistor, M4B, seventeenth thin film transistor, M5, fifth thin film transistor, M6, sixth thin film transistor, M7, seventh thin film transistor, MBA, eighth thin film transistor, M8B, eighteenth thin film transistor, M9, ninth thin film transistor, M10, tenth thin film transistor, M11, eleventh thin film transistor, M11B, nineteenth thin film transistor, M12, twelfth thin film transistor, M13, thirteenth thin film transistor, M14, fourteenth thin film transistor, M15, fifteenth thin film transistor, C1, bootstrap capacitor;

Gn, Scanning signal of the gate driving unit circuit of the nth stage, netAn, pull-up control node, netBn, holding control node, VGH, high level, VSS, low level, CKm, first clock signal, CKm+2, second clock signal, CK1, first stage clock signal, CKM, last stage clock signal, Gn−1, the scanning signal of the gate driving unit circuit of the (n−1)th stage, Gn+1, the scanning signal of the gate driving unit circuit of the (n+1)th stage, CLR, clearing and reset signal, GSP1, forward scanning start signal, GSP2, backward scanning start signal, Tn, cascade node of the gate driving unit circuit of the nth stage, Tn−1, cascade node of the gate driving unit circuit of the (n−1)th stage, Tn+1, cascade node of the gate driving unit circuit of the (n+1)th stage, TC, touch control signal.

### DETAILED DESCRIPTION OF EMBODIMENTS

To describe the technical solutions in the embodiments of the present invention or in the prior art more clearly, the following describes specific implementations of the present invention with reference to the accompanying drawings. Apparently, the accompanying drawings in the following description are merely some of the embodiments of the present invention. For a person of ordinary skill in the art, without creative effort, other accompanying drawings may be obtained according to the accompanying drawings, and other implementations may be obtained.

For brevity, only parts related to the present invention are schematically shown in the figures, and they do not represent an actual structure of the product. In addition, in order to make the diagram simple and easy to understand, only one of the components that have the same structures or functions in some diagrams is shown or indicated. In this context, “a” means not only “only one”, but also “more than one”.

The gate driving circuit of the present invention uses M (M>1 and M is an integer) clock signals CKm (m=1, 2, . . . M). In the following embodiments, CK1 is recorded as a first-stage clock signal, CKM is recorded as a last-stage clock signal, CKm is taken as a first clock signal, and CKm+2 is taken as a second clock signal. It should be noted that the second clock signal is not limited to CKm+2, and the second clock signal may be CKm+3, CKm+4, or the like. Wherein CK−1 is equivalent to CK (M−1), CK0 is equivalent to CKM, CK1 is equivalent to CKM+1, and so on.

It should be noted that, for the gate driving circuit formed by N stages of gate driving unit circuit, in the following embodiment, the first-stage gate driving unit circuit refers to the 1st stage gate driving unit circuit, and the last-stage gate driving unit circuit refers to the Nth stage gate driving unit circuit. For the nth stage gate driving unit circuit, the n-th stage gate driving unit circuit may be referred to as the current stage gate driving unit circuit, the (n−1)th stage gate driving unit circuit may be referred to as a previous stage gate driving unit circuit, and the (n+1)th stage gate driving unit circuit may be referred to as a following stage gate driving unit circuit.

In the following embodiments, the thin film transistor includes a control end, a first path end, and a second path end, wherein the control end is a gate, the first path end is a source, and the second path end is a drain. In an optional implementation, the first path end may be a drain, and the second path end is a source. When the control end is supplied with a high level, the first path end and the second path end are connected via a semiconductor layer, and in this case, the thin film transistor is in an enabled state.

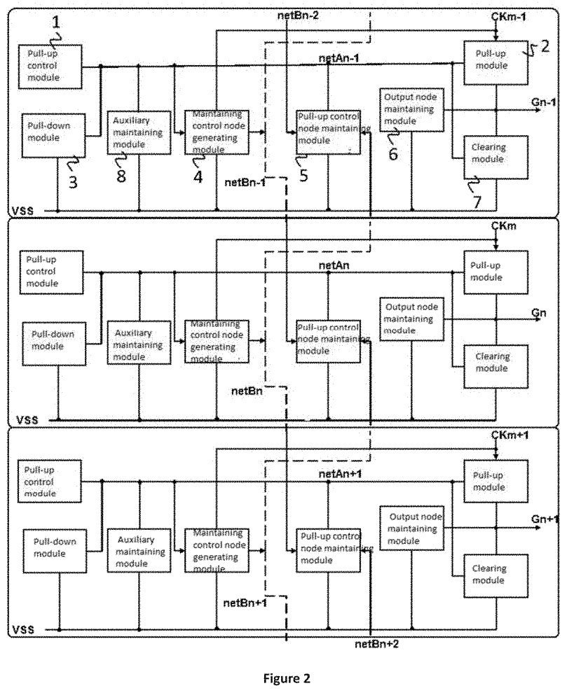

FIG. 2 is a schematic circuit diagram of a gate driving unit circuit and a gate driving circuit formed thereby according to an embodiment of the present invention. As shown in FIG. 2, the gate driving unit circuit is adapted to perform multi-stage connection to form a gate driving circuit, including a pull-up control module 1, a pull-up module 2, a pull-down module 3, a holding control node generation module 4, a pull-up control node holding module 5, and an output node holding module 6.

The pull-up control module 1, the pull-up module 2, the holding control node generation module 4, and the pull-up control node holding module 5 are connected to the pull-up control node netAn. The pull-up module 2 and the output node holding module 6 are connected to a current stage scanning signal line.

When the gate driving unit circuit is not a first-stage gate driving unit circuit or a last-stage gate driving unit circuit, the pull-up control node holding module 5 is connected to a previous stage holding control node of the holding control node generation module 4 of the previous stage gate driving unit circuit and a following stage holding control node of the holding control node generation module 4 of the following stage gate driving unit circuit, and holds the current stage pull-up control node under control of the previous stage holding control node and the following stage holding control node.

When the gate driving unit circuit is a first-stage gate driving unit circuit, the pull-up control node holding module 5 is connected to the last-stage clock signal and a following stage holding control node of the holding control node generation module 4 of the following stage gate driving unit circuit, and holds the current stage pull-up control node under control of the last-stage clock signal and the following stage holding control node.

When the gate driving unit circuit is a last-stage gate driving unit circuit, the pull-up control node holding module 5 is connected to the first-stage clock signal and a previous stage holding control node of the holding control node generation module 4 of the previous stage gate driving unit circuit, and holds the current stage pull-up control node under control of the first-stage clock signal and the previous stage holding control node.

The current stage pull-up control node holding module 5 of the gate driving unit circuit in the embodiments of the present invention is controlled by a holding control node generation module of a previous stage and a following stage, and the holding control node generation module 4 and the pull-up control node holding module 5 have the same working state in a forward scanning and a backward scanning process, avoiding the problem that the circuit function is ineffective because a thin film transistor suffers from a bias stress to cause a threshold voltage drift after a scanning direction is switched, and improving the circuit reliability.

As shown in FIG. 2, the N stages of gate driving unit circuits may implement the gate driving circuit of the present invention by means of cascading. According to a preferred implementation of the present invention, N may be a positive integer greater than 3.

In the gate driving circuit of the present invention, when 2≤n≤N−1, the pull-up control node holding module 5 of the nth stage gate driving unit circuit is respectively connected to the holding control node generation module 4 of the (n−1)th stage gate driving unit circuit and the holding control node generation module 4 of the (n+1)th stage gate driving unit circuit.

When n=1, the pull-up control node holding module 5 of the nth stage gate driving unit circuit is input the last stage clock signal CKM, and is connected to the holding control node generation module 4 of the (n+1)th stage gate driving unit circuit.

When n=N, the pull-up control node holding module 5 of the nth stage gate driving unit circuit is input the first-stage clock signal CK1, and is connected to the holding control node generation module 4 of the (n−1)th stage gate driving unit circuit.

The gate driving unit circuit in the embodiments of the present invention has a lot of specific embodiments, wherein the circuit structures of the gate driving unit circuit of each stage are the same, and a difference lies only in that signals input to some thin film transistors are different. The following describes specific embodiments of the gate driving unit circuit based on the gate driving unit circuit of the nth stage, where 1≤n≤N, and n is a positive integer.

### Embodiment 1

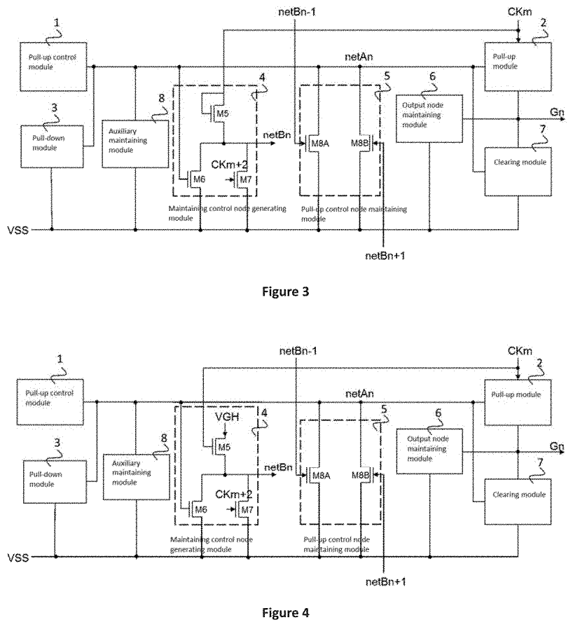

FIG. 3 is a schematic circuit diagram of a gate driving unit circuit according to Embodiment 1 of the present invention. As shown in FIG. 3, the gate driving unit circuit includes a pull-up control module 1, a pull-up module 2, a pull-down module 3, a holding control node generation module 4, a pull-up control node holding module 5, and an output node holding module 6.

The holding control node generation module 4 is responsible for generating a holding control signal to control the holding control node netBn. The holding control node netBn is connected to the pull-up control node holding module 5 of the gate driving unit circuit of the previous stage and the following stage, and is responsible for performing holding control on the pull-up control node of the previous stage and the following stage.

The holding control node generation module 4 includes a fifth thin film transistor M5, a sixth thin film transistor M6, and a seventh thin film transistor M7.

A first path end of the fifth thin film transistor M5 is connected to a current stage holding control node netBn, a control end and a second path end thereof input a first clock signal CKm, and the fifth thin film transistor M5 is configured to charge the current stage holding control node netBn.

A control end of the sixth thin film transistor M6 is connected to the current stage pull-up control node netAn, a first path end is connected to a low level VSS, a second path end is connected to a holding control node netBn, and the sixth thin film transistor M6 is configured to prohibit, during operation of the current stage gate driving unit circuit, the output of the current stage holding control node netBn.

A control end of the seventh thin film transistor M7 is input a second clock signal CKm+2, a first path end is connected to a low level VSS, a second path end is connected to the current stage holding control node netBn, and the seventh thin film transistor M7 is configured to discharge the current stage holding control node netBn.

The pull-up control node holding module 5 is connected to the previous stage holding control node netBn−1 of the holding control node generation module 4 of the previous stage gate driving unit circuit and the following stage holding control node netBn+1 of the holding control node generation module 4 of the following stage gate driving unit circuit, so as to hold the current stage pull-up control node netAn, so that the current stage pull-up control node netAn is held at a stable low potential without being interfered by other signals, so as to ensure relatively high reliability of the circuit.

The pull-up control node holding module 5 includes an eighth thin film transistor M8A and an eighteenth thin film transistor M8B.

A control end of the eighth thin film transistor M8A is connected to a previous stage holding control node netBn−1 of the previous stage gate driving unit circuit, a first path end is connected to a low level VSS, and a second path end is connected to a current stage pull-up control node netAn. In an optional implementation, the control end of the eighth thin film transistor M8A of the first-stage gate driving unit circuit is input the last stage clock signal CKM.

A control end of the eighteenth thin film transistor M8B is connected to a following stage holding control node netBn+1 of a following stage gate driving unit circuit, a first path end is connected to a low level VSS, and a second path end is connected to a current stage pull-up control node netAn.

In an optional implementation, the control end of the eighteenth thin film transistor M8B of the last-stage gate driving unit circuit is input the first-stage clock signal CK1.

The eighth thin film transistor M8A and the eighteenth thin film transistor M8B are respectively controlled by the holding control node of the previous stage gate driving unit circuit and the following stage gate driving unit circuit, and alternately hold the current stage pull-up control node netAn.

The pull-up control module 1 is configured to charge the current stage pull-up control node netAn, and can implement a forward and backward scanning function in connection with the pull-down module 3 and timing control.

The pull-up module 2 is controlled by the pull-up control node netAn, and input a first clock signal CKm to generate a current stage scanning signal Gn.

The pull-down module 3 is responsible for receiving a second clock signal CKm+2, and performing clearing reset on the pull-up control node netAn.

The output node holding module 6 is responsible for holding the scanning signal Gn of the current stage.

In some implementations, the gate driving unit circuit in the embodiments of the present invention may further include a clearing module 7 and an auxiliary holding module 8.

The clearing module 7 is responsible for performing a clearing reset operation on the current stage pull-up control node netAn, the current stage holding control node netBn, and the current stage scanning signal Gn after each frame of image ends and when the apparatus is switched on.

The auxiliary holding module 8 is responsible for holding the current stage pull-up control node netAn in a startup phase during the forward scanning and backward scanning.

It should be noted that, in the present invention, the clearing module 7 and the auxiliary holding module 8 are functional modules added according to need in actual use. Whether the circuit includes the foregoing modules is not limited in the present invention. In addition, other functional modules may be added to meet an actual requirement. On this basis, conventional improvements should fall within the protection scope of the present invention.

In the gate driving unit circuit of the embodiment of the present invention, the current stage pull-up control node holding module 5 is controlled by the holding control node generation module 4 in the previous stage and in the following stage. The holding control node generation module 4 and the pull-up control node holding module 5 have the same working state in the forward scanning and the backward scanning processes, so that a problem of circuit function failure caused by a threshold voltage drift which is caused by a bias stress of the thin film transistor after a scanning direction is switched can be avoided. The pull-up control node holding module 5 includes two thin-film transistors, which can alternately hold the pull-up control node netAn. One of the two thin-film transistors can hold the pull-up control node at any time, thereby improving circuit reliability. In addition, because no U2D and D2U control signals are required, layout space is saved, and the frame of the display panel is narrowed.

### Embodiment 2

FIG. 4 is a schematic circuit diagram of a gate driving unit circuit according to Embodiment 2 of the present invention. As shown in FIG. 4, the difference between the gate driving unit circuit and Embodiment 1 shown in FIG. 3 lies in that a control end of a fifth thin film transistor M5 included in a holding control node generation module 4 is input a first clock signal CKm, a first path end is connected to a current stage holding control node netBn, and a second path end is changed to be connected to a high level VGH. The implementations of other circuit parts are the same as those of Embodiment 1 shown in FIG. 3.

### Embodiment 3

FIG. 5 is a schematic circuit diagram of a gate driving unit circuit according to Embodiment 3 of the present invention. As shown in FIG. 5, the gate driving unit circuit includes a pull-up control module 1, a pull-up module 2, a pull-down module 3, a holding control node generation module 4, a pull-up control node holding module 5, and an output node holding module 6. The circuit structures of the holding control node generation module 4 and the pull-up control node holding module 5 are the same as those in Embodiment 1 shown in FIG. 3.

The pull-up control module 1 includes a first thin film transistor M1A and a sixteenth thin film transistor M1B.

A control end of the first thin film transistor M1A is connected to a scanning signal line Gn−1 of a previous stage gate driving unit circuit, a first path end is connected to a current stage pull-up control node netAn, and a second path end is connected to a high level VGH. In an optional implementation, the control end of the first thin film transistor M1A of the first-stage gate driving unit circuit is input the forward scanning start signal GSP1. The first thin film transistor M1A is configured to pre-charge the current stage pull-up control node netAn during forward scanning.

A control end of the sixteenth thin film transistor M1B is connected to a scanning signal line Gn+1 of a following stage gate driving unit circuit, a first path end is connected to a current stage pull-up control node netAn, and a second path end is connected to a high level VGH. In an optional implementation, the control end of the sixteenth thin film transistor M1B of the last-stage gate driving unit circuit is input a backward scanning start signal GSP2. The sixteenth thin film transistor M1B is configured to pre-charge the current stage pull-up control node netAn during backward scanning.

In the embodiment of the present invention, by connecting the high level VGH to the second path end, the pull-up control module 1 controls to pre-charge the current stage pull-up control node during the forward and backward scanning, reducing the bias stress and threshold voltage drift of the thin film transistor.

The pull-up module 2 includes a tenth thin film transistor M10. A control end of the tenth thin film transistor M10 is connected to a current stage pull-up control node netAn, a first path end is connected to a current stage scanning signal line Gn, and a second path end is connected to a first clock signal CKm. The tenth thin film transistor M10 is configured to perform pull-up output to and pull-down clearing of the current stage scanning signal Gn.

The pull-down module 3 includes a ninth thin film transistor M9. A control end of the ninth thin film transistor M9 is connected to a second clock signal CKm+2, a first path end is connected to a low level VSS, and a second path end is connected to a current stage pull-up control node netAn.

The ninth thin film transistor M9 is configured to discharge the current stage pull-up control node netAn.

The output node holding module 6 includes an eleventh thin film transistor M11A. A control end of the eleventh thin film transistor M11A is connected to the second clock signal CKm+2, a first path end is connected to the low level VSS, and a second path end is connected to the current stage scanning signal line Gn. The eleventh thin film transistor M11A is configured to hold the current stage scanning signal Gn.

In some implementations, the gate driving unit circuit in the embodiment of the present invention may further include a clearing module 7 and an auxiliary holding module 8.

The clearing module 7 includes a second thin film transistor M2, a third thin film transistor M3, and a twelfth thin film transistor M12.

A control end of the second thin film transistor M2 is input the clearing signal CLR, a first path end and a second path end thereof are respectively connected to the low level VSS and the current stage pull-up control node netAn, and the second thin film transistor M2 is configured to perform a clearing reset operation on the current stage pull-up control node netAn after each frame of image ends and when the apparatus is switched off.

A control end of the third thin film transistor M3 is input a clearing signal CLR, a first path end and a second path end thereof are respectively connected to a low level VSS and a current stage holding control node netBn, and the third thin film transistor M3 is configured to perform a clearing reset operation on the current stage holding control node netBn after each frame of image ends and when the apparatus is switched off.

A control end of the twelfth thin film transistor M12 is input a clearing signal CLR, a first path end and a second path end thereof are respectively connected to a low level VSS and a current stage scanning signal line, and the twelfth thin film transistor M12 is configured to perform a clearing reset operation on the current stage scanning signal Gn after each frame of image ends and when the apparatus is switched off.

The auxiliary holding module 8 includes a fourth thin film transistor M4A and a seventeenth thin film transistor M4B.

A control end of the fourth thin film transistor M4A is input a forward scanning start signal GSP1, and a first path end and a second path end thereof are respectively connected to a low level VSS and a current stage pull-up control node netAn. In an optional implementation, the control end of the fourth thin film transistor M4A of the gate driving unit circuit of the first three stages is input a low level VSS. The fourth thin film transistor M4A is configured to hold the pull-up control node netAn of the current stage in the start phase during the forward scanning of image.

A control end of the seventeenth thin film transistor M48 is input a backward scanning start signal GSP2, and a first path end and a second path end thereof are respectively connected to a low level VSS and a current stage pull-up control node netAn. In an optional implementation, the control end of the seventeenth thin film transistor M4B of the gate driving unit circuit of the last three stages is input a low level VSS. The seventeenth thin film transistor M4B is configured to hold the current stage up-pull control node netAn in the start phase during a backward scanning of image.

In some implementations, the gate driving unit circuit in the embodiment of the present invention may further include a bootstrap capacitor C, where the bootstrap capacitor C1 is connected between the current stage pull-up control node netAn and the current stage scan signal line, and pull-up, in an output process, a potential of the current stage pull-up control node netAn through capacitive coupling action, so as to improve the charging speed of the current stage scanning signal line.

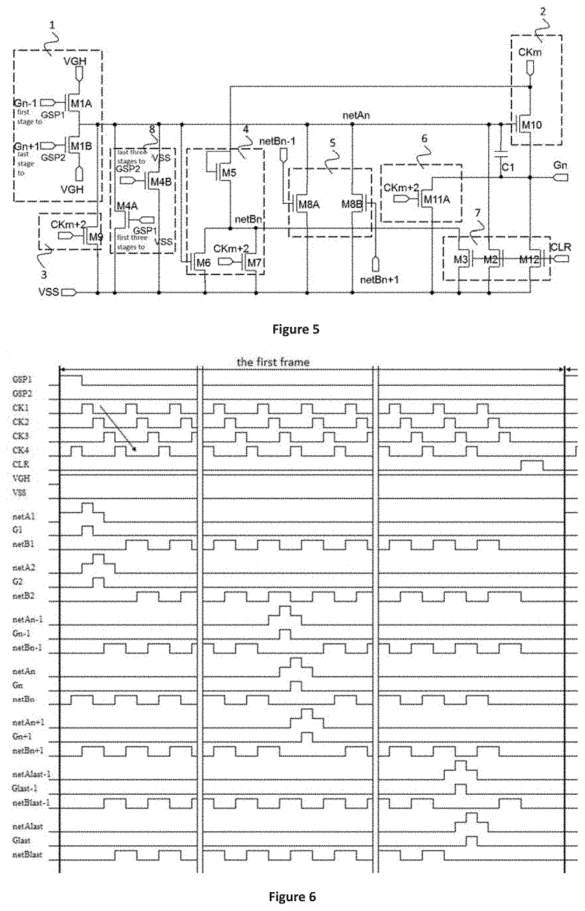

FIG. 6 is a schematic diagram of a driving waveform of a gate driving unit circuit shown in FIG. 5 in a forward scanning. Wherein,

GSP1 is the forward scanning start signal, and is responsible for starting during the forward scanning.

GSP2 is the backward scanning start signal, and is responsible for starting during the backward scanning.

CK1, CK2, CK3, and CK4 are clock signals, which are sequentially output during forward scanning.

The CLR is a clearing reset signal. It is used to clear the charge of the nodes inside the circuit when each frame ends and when the apparatus is switched on or off.

VGH is a high level VGH. It is mainly used for the input of the pull-up control module 1.

VSS is a low level VSS that provides the low potential of the scanning signal Gn.

Other waveforms, such as netA1, netA2, netAlast−1 and netAlast, are the output waveforms of the nodes inside the circuit. G1, G2 and Glast are the waveforms of the scanning signals output by the gate driving unit circuits of each stage.

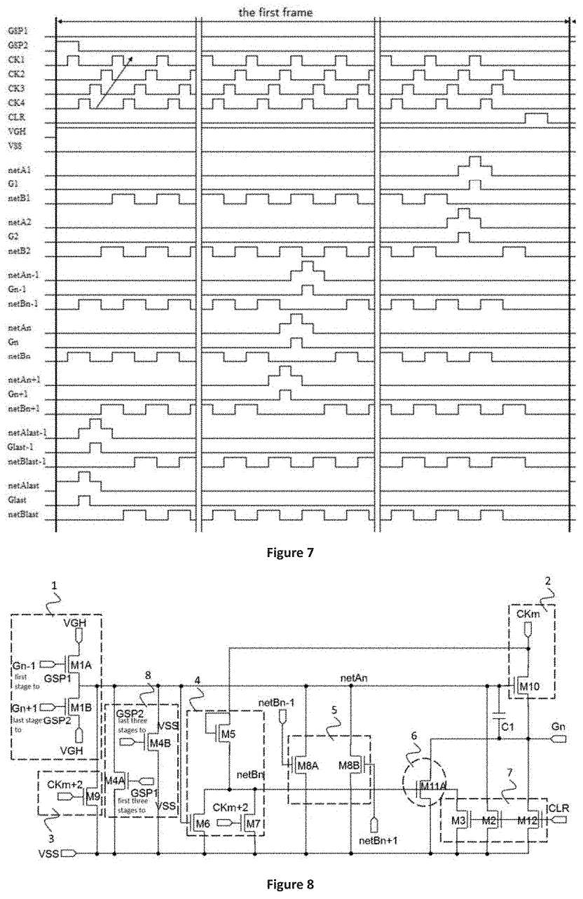

FIG. 7 is a schematic diagram of a driving waveform of a gate driving unit circuit shown in FIG. 5 in a backward scanning. Wherein,

GSP1 is the forward scanning start signal, and is responsible for starting during the forward scanning.

GSP2 is the backward scanning start signal, and is responsible for starting during the backward scanning.

CK1, CK2, CK3, and CK4 are clock signals, which are sequentially output during the backward scanning.

The CLR is a clearing reset signal. It is used to clear the charge of the nodes inside the circuit when each frame ends and when the apparatus is switched on or off.

VGH is a high level VGH. It is mainly used for the input of the pull-up control module 1.

VSS is a low level VSS that provides the low potential of the scanning signal Gn.

Other waveforms, such as netA1, netA2, netAlast−1 and netAlast, are the output waveforms of the nodes inside the circuit. G1, G2 and Glast are the waveforms of the scanning signals output by the gate driving unit circuits of each stage.

### Embodiment 4

FIG. 8 is a schematic circuit diagram of a gate driving unit circuit according to Embodiment 4 of the present invention. As shown in FIG. 8, the gate driving unit circuit is different from Embodiment 3 shown in FIG. 5 in that:

The gate of the eleventh thin film transistor M11A in the output node holding module 6 is connected to the current stage holding control node netBn, the first path end is connected to the low level VSS, and the second path end is connected to the current stage scanning signal line Gn.

Implementations of other circuit parts are the same as those in Embodiment 3 shown in FIG. 5.

### Embodiment 5

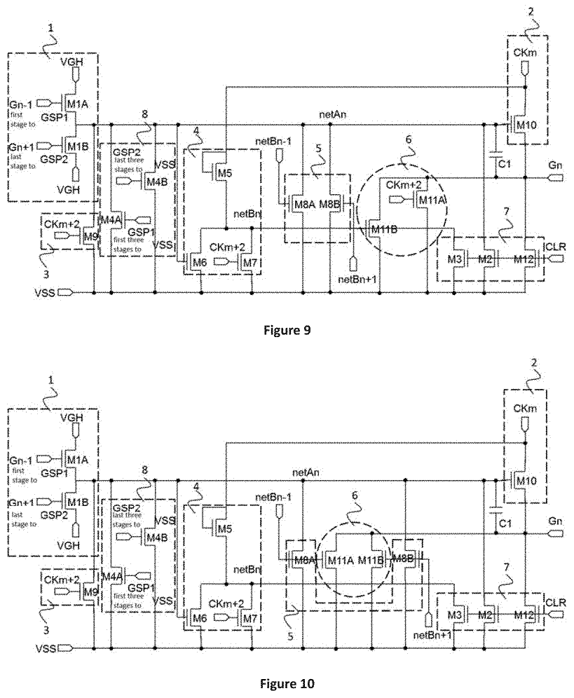

FIG. 9 is a schematic circuit diagram of a gate driving unit circuit according to Embodiment 5 of the present invention. As shown in FIG. 9, on the basis of Embodiment 3 shown in FIG. 7, the output node holding module 6 of the gate driving unit circuit further includes a nineteenth thin film transistor M11B, wherein a control end of the nineteenth thin film transistor M11B is connected to a current stage holding control node netBn, a first path end is connected to a low level VSS, and a second path end is connected to a current stage scanning signal line Gn. The eleventh thin film transistor M11A and the nineteenth thin film transistor M11B jointly hold a scanning signal Gn of the current stage, so as to enhance the holding capability.

### Embodiment 6

FIG. 10 is a schematic circuit diagram of a gate driving unit circuit according to Embodiment 6 of the present invention. As shown in FIG. 10, the gate driving unit circuit is different from Embodiment 5 shown in FIG. 9 in that:

A control end of the eleventh thin film transistor M11A in the output node holding module 6 is connected to a holding control node netBn−1 of a previous stage gate driving unit circuit, and a first path end and a second path end thereof are respectively connected to a low level VSS and a current stage scanning signal line.

A control end of the nineteenth thin film transistor M11B is connected to a holding control node netBn+1 of a following stage gate driving unit circuit, and a first path end and a second path end thereof are respectively connected to a low level VSS and a current stage scanning signal line.

### Embodiment 7

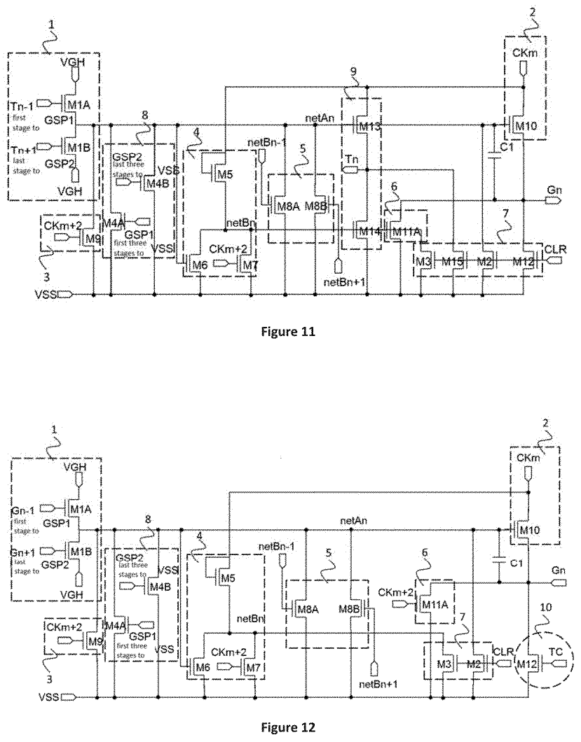

FIG. 11 is a schematic circuit diagram of a gate driving unit circuit according to Embodiment 7 of the present invention. As shown in FIG. 11, the gate driving unit circuit is different from Embodiment 4 shown in FIG. 8 in that: The gate driving unit circuit further includes a cascade node generation module 9, and the cascade node generation module 9 includes a thirteenth thin film transistor M13 and a fourteenth thin film transistor M14.

A control end of the thirteenth thin film transistor M13 is connected to a current stage pull-up control node netAn, a first path end is connected to a current stage cascade node Tn, and a second path end is connected to a first clock signal CKm. A control end of the fourteenth thin film transistor M14 is connected to a current stage holding control node netBn, a second path end is connected to a current stage cascade node Tn, and a first path end is connected to a low level VSS.

A control end of the first thin film transistor M1A in the pull-up control module 1 is connected to a cascade node Tn−1 in a previous stage gate driving unit circuit, and a control end of the sixteenth thin film transistor M1B is connected to a cascade node Tn+1 in a following stage gate driving unit circuit.

The clearing module 7 further includes a fifteenth thin film transistor M15, wherein a control end of the fifteenth thin film transistor M15 is input a clearing signal CLR, a first path end is connected to a low level VSS, and a second path end is connected to a cascade node Tn of the current stage. The fifteenth thin film transistor M15 is configured to clear the current stage cascade node Tn after one frame is displayed and when the apparatus is switched on or off.

The cascade node generation module 9 is responsible for generating a cascade signal to control the cascade node Tn of the current stage. In addition, the cascade node Tn of the current stage is connected to the pull-up control module 1 of the gate driving unit circuit in the previous stage and following stage, so that the gate driving circuit implements a forward and backward scanning function.

### Embodiment 8

FIG. 12 is a schematic circuit diagram of a gate driving unit circuit according to Embodiment 8 of the present invention. As shown in FIG. 12, the gate driving unit circuit is improved on the basis of Embodiment 3 shown in FIG. 5, and may be used for an embedded touch display. The specific points of improvement are as follows:

A touch control signal TC that is input externally is added.

A touch control holding module 10 is added, wherein the touch control holding module 10 includes a twelfth thin film transistor M12, a control end of the twelfth thin film transistor M12 is input a touch control signal TC, and a first path end and a second path end thereof are respectively connected to a low level VSS and a current stage scanning signal line. The touch control holding module 10 is configured to perform holding control on a scanning signal Gn of the current stage gate driving unit circuit during a touch control period, so that the gate driving circuit supports a pause at any time during the display period, and may be used for an embedded touch display screen of 120 Hz.

Correspondingly, the clearing module 7 includes a second thin film transistor M2 and a third thin film transistor M3. The control end of the second thin film transistor M2 is input the clearing signal CLR, the first path end and the second path end thereof are respectively connected to the low level VSS and the current stage pull-up control node netAn, and the second thin film transistor M2 is configured to perform a clearing reset operation on the current stage pull-up control node netAn after each frame of image ends and when the apparatus is switched on or off.

A control end of the third thin film transistor M3 is input a clearing signal CLR, the first path end and the second path end thereof are respectively connected to a low level VSS and a current stage holding control node netBn, and the third thin film transistor M3 is configured to perform a clearing reset operation on the current stage holding control node netBn after each frame of image ends and when the apparatus is switched on or off.

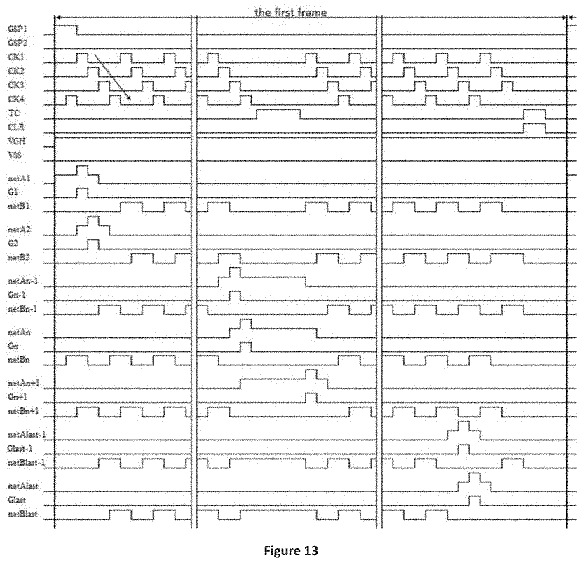

FIG. 13 is a schematic diagram of a driving waveform of a gate driving unit circuit shown in FIG. 12 in a forward scanning. Wherein,

GSP1 is the forward scanning start signal, and is responsible for starting during the forward scanning.

GSP2 is the backward scanning start signal, and is responsible for starting during the backward scanning.

CK1, CK2, CK3, and CK4 are clock signals, which are sequentially output during the forward scanning.

CLR is a clearing reset signal. It is used to clear the charge of the nodes inside the circuit when each frame ends and when the apparatus is switched on or off.

TC is a touch control signal during the touch control period, and is responsible for holding the current stage scanning signal during the touch control period.

VGH is a high level VGH. It is mainly used for the input of the pull-up control module 1.

VSS is a low level VSS that provides the low potential of the scanning signal Gn.

Other waveforms, such as netA1, netA2, netAlast−1 and netAlast, are the output waveforms of the nodes inside the circuit. G1, G2 and Glast are the waveforms of the scanning signals output by the gate driving unit circuits of each stage.

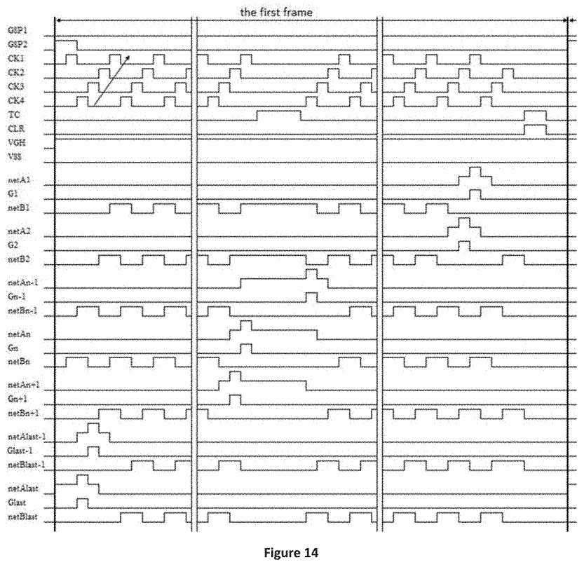

FIG. 14 is a schematic diagram of a driving waveform of a gate driving unit circuit shown in FIG. 12 in a backward scanning. Wherein,

GSP1 is the forward scanning start signal, and is responsible for starting during the forward scanning.

GSP2 is the backward scanning start signal, and is responsible for starting during the backward scanning.

CK1, CK2, CK3, and CK4 are clock signals, which are sequentially output during the backward scanning.

CLR is a clearing reset signal. It is used to clear the charge of the nodes inside the circuit when each frame ends and when the apparatus is switched on or off.

TC is a touch control signal during the touch control period, and is responsible for holding the current stage scanning signal during the touch control period.

VGH is a high level VGH. It is mainly used for the input of the pull-up control module 1.

VSS is a low level VSS that provides the low potential of the scanning signal Gn.

Other waveforms, such as netA1, netA2, netAlast−1 and netAlast, are the output waveforms of the nodes inside the circuit. G1, G2 and Glast are the waveforms of the scanning signals output by the gate driving unit circuits of each stage.

It should be noted that, in the foregoing Embodiment 3 to Embodiment 8, the fifth thin film transistor M5 included in the holding control node generation module 4 may also be implemented according to Embodiment 2 shown in FIG. 4. That is, a gate of the fifth thin film transistor M5 is input a first clock signal CKm, a first path end is connected to a current stage holding control node netBn, and a second path end is changed to be connected to a high level VGH.

An embodiment of the present invention further provides a liquid crystal display apparatus, where the liquid crystal display apparatus includes the foregoing gate driving circuit, and the gate driving circuit may be a unilateral drive manner, or may be a bilateral drive manner.

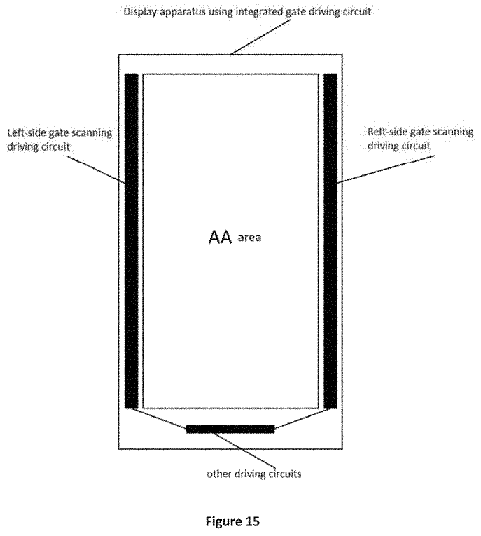

FIG. 15 is an example diagram of a liquid crystal display apparatus that uses a gate driving circuit according to an embodiment of the present invention. As an optional implementation of the embodiment of the present invention, the AA area in the figure represents a display area. The liquid crystal display apparatus uses a left-right interleaved drive architecture, including a left-side gate driving circuit, a right-side gate driving circuit, and other drive circuits.

It should be noted that the foregoing embodiments may be freely combined according to a requirement. The foregoing description is merely some preferred implementations of the present invention. It should be noted that, for a person of ordinary skill in the art, some improvements and adjustments may be made without departing from the principles of the present invention, and these improvements and adjustments shall also be considered as falling into the protection scope of the present invention.

1. A gate driving unit circuit, adapted for multi-stage connection to form a gate driving circuit, characterized in comprising a pull-up control module, a pull-up module, a pull-down module, a holding control node generation module, a pull-up control node holding module, and an output node holding module, wherein the pull-up control module, the pull-up module, the holding control node generation module, and the pull-up control node holding module are connected to a current stage pull-up control node, the pull-up module and the output node holding module are connected to a current stage scanning signal line;
wherein, when the gate driving unit circuit is not a first-stage gate driving unit circuit or a last-stage gate driving unit circuit, the pull-up control node holding module is connected to a previous stage holding control node of the holding control node generation module of a previous stage gate driving unit circuit and a following stage holding control node of the holding control node generation module of a following stage gate driving unit circuit, and holds the current stage pull-up control node under control of the previous stage holding control node and the following stage holding control node;
when the gate driving unit circuit is the first-stage gate driving unit circuit, the pull-up control node holding module is connected to a last-stage clock signal and the following stage holding control node of the holding control node generation module of the following stage gate driving unit circuit, and holds the current stage pull-up control node under control of the last-stage clock signal and the following stage holding control node; and
when the gate driving unit circuit is the last-stage gate driving unit circuit, the pull-up control node holding module is connected to a first-stage clock signal and the previous stage holding control node of the holding control node generation module of the previous stage gate driving unit circuit, and holds the current stage pull-up control node under control of the first-stage clock signal and the previous stage holding control node.

2. The gate driving unit circuit according to claim 1, wherein the holding control node generation module comprises a fifth thin film transistor, a sixth thin film transistor, and a seventh thin film transistor;
the fifth thin film transistor is configured to charge the current stage holding control node, a first path end of the fifth thin film transistor is connected to the current stage holding control node, and a control end and a second path end thereof input a first clock signal;
the sixth thin film transistor is configured to prohibit the output of the current stage holding control node during operation of the current stage gate driving unit circuit, where a control end of the sixth thin film transistor is connected to the current stage up-pull control node, a first path end is connected to a low level, and a second path end is connected to the current stage holding control node; and
the seventh thin film transistor is configured to discharge the current stage holding control node, a control end of the seventh thin film transistor is input a second clock signal, a first path end is connected to a low level, and a second path end is connected to the current stage holding control node.

3. The gate driving unit circuit according to claim 1, wherein the holding control node generation module comprises a fifth thin film transistor, a sixth thin film transistor, and a seventh thin film transistor;
the fifth thin film transistor is configured to charge the current stage holding control node, a control end of the fifth thin film transistor is input a first clock signal, a first path end is connected to the current stage holding control node, and a second path end is connected to a high level;
the sixth thin film transistor is configured to prohibit the output of the current stage holding control node during operation of the current stage gate driving unit circuit, where a control end of the sixth thin film transistor is connected to the current stage up-pull control node, a first path end is connected to a low level, and a second path end is connected to the current stage holding control node; and
the seventh thin film transistor is configured to discharge the current stage holding control node, a control end of the seventh thin film transistor is input a second clock signal, a first path end is connected to a low level, and a second path end is connected to the current stage holding control node.

4. The gate driving unit circuit according to claim 2, wherein the pull-up control node holding module comprises an eighth thin film transistor and an eighteenth thin film transistor,
a control end of the eighth thin film transistor is connected to the previous stage holding control node, a first path end is connected to a low level, and a second path end is connected to a current stage pull-up control node; wherein the control end of the eighth thin film transistor of the first-stage gate driving unit circuit is input a last-stage clock signal;
a control end of the eighteenth thin film transistor is connected to the following stage holding control node, a first path end is connected to a low level, and a second path end is connected to a current stage pull-up control node; wherein the control end of the eighteenth thin film transistor of the first-stage gate driving unit circuit is input a first-stage clock signal.

5. The gate driving unit circuit according to claim 2, wherein the pull-up control module comprises a first thin film transistor and a sixteenth thin film transistor,
the first thin film transistor is configured to pre-charge a current stage pull-up control node during a forward scanning, where a control end of the first thin film transistor is connected to a scan signal line of a previous stage gate driving unit circuit, a first path end is connected to the current stage pull-up control node, and a second path end is connected to a high level; wherein the control end of the first thin film transistor of the first-stage gate driving unit circuit is input a forward scanning start signal;
the sixteenth thin film transistor is configured to pre-charge a current stage pull-up control node during backward scanning, where a control end of the sixteenth thin film transistor is connected to a scanning signal line of a following stage gate driving unit circuit, a first path end is connected to the current stage pull-up control node, and a second path end is connected to a high level; the control end of the sixteenth thin film transistor of the last-stage gate driving unit circuit is input a backward scanning start signal.

6. The gate driving unit circuit according to claim 4, wherein the circuit further comprises a cascade node generation module; the cascade node generation module includes a thirteenth thin film transistor and a fourteenth thin film transistor, a control end of the thirteenth thin film transistor is connected to a current stage pull-up control node, and a first path end and a second path end thereof are respectively connected to the current cascade node and the first clock signal; and a control end of the fourteenth thin film transistor is connected to a current stage holding control node, and a first path end and a second path end thereof are respectively connected to a low level and a current stage cascade node;
the pull-up control module comprises a first thin film transistor and a sixteenth thin film transistor, a control end of the first thin film transistor is connected to a previous stage cascade node of a previous stage gate driving unit circuit, a first path end is connected to a current stage pull-up control node, and a second path end is connected to a high level; a control end of the sixteenth thin film transistor is connected to a following stage cascade node of the following stage gate driving unit circuit, a first path end is connected to a current stage pull-up control node, and a second path end is connected to a high level.

7. The gate driving unit circuit according to claim 2, wherein the output node holding module comprises an eleventh thin film transistor, the eleventh thin film transistor is configured to hold a current stage scanning signal, a control end of the eleventh thin film transistor is connected to a second clock signal, and a first path end and a second path end thereof are respectively connected to a low level and a current stage scanning signal line.

8. The gate driving unit circuit according to claim 2, wherein the output node holding module comprises an eleventh thin film transistor, the eleventh thin film transistor is configured to hold a current stage scanning signal, a control end of the eleventh thin film transistor is connected to a holding control node of the current stage, and a first path end and a second path end thereof are respectively connected to a low level and a current stage scanning signal line.

9. The gate driving unit circuit according to claim 7, wherein the output node holding module further comprises a nineteenth thin film transistor, a control end of the nineteenth thin film transistor is connected to a current stage holding control node, and a first path end and a second path end thereof are respectively connected to a low level and a current stage scanning signal line.

10. The gate driving unit circuit according to claim 2, wherein the output node holding module comprises an eleventh thin film transistor and a nineteenth thin film transistor, and
a control end of an eleventh thin film transistor is connected to the previous stage holding control node, and a first path end and a second path end thereof are respectively connected to a low level and a current stage scanning signal line; a control end of the nineteenth thin film transistor is connected to the following stage holding control node, and a first path end and a second path end thereof are respectively connected to a low level and a current stage scanning signal line.

11. The gate driving unit circuit according to claim 2, wherein the circuit further comprises a touch control holding module; wherein the touch control holding module comprises a twelfth thin film transistor, a control end of the twelfth thin film transistor is input a touch control signal, and a first path end and a second path end thereof are respectively connected to a low level and a current stage scanning signal line.

12. The gate driving unit circuit according claim 2, wherein the pull-up module comprises a tenth thin film transistor, a control end of the tenth thin film transistor is connected to a current stage pull-up control node, and a first path end and a second path end thereof are respectively connected to a scanning signal line of the current stage and a first clock signal.

13. The gate driving unit circuit according to claim 2, wherein the pull-down module comprises a ninth thin film transistor, a control end of the ninth thin film transistor is input a second clock signal, and a first path end and a second path end thereof are respectively connected to a low level and a current stage pull-up control node.

14. The gate driving unit circuit according to claim 2, wherein the circuit further comprises an auxiliary holding module; and the auxiliary holding module comprises a fourth thin film transistor and a seventeenth thin film transistor;
a control end of the fourth thin film transistor is input a forward scanning start signal, and a first path end and a second path end thereof are respectively connected to a low level and a current stage pull-up control node; wherein the control end of the fourth thin film transistor of the gate driving unit circuits in the first three stages is input a low level;
a control end of the seventeenth thin film transistor is input a backward scanning start signal, and a first path end and a second path end thereof are respectively connected to a low level and a current stage pull-up control node; wherein the control end of the seventeenth thin film transistor of the gate driving unit circuit in the last three stages is input a low level.

15. The gate driving unit circuit according to claim 2, wherein the circuit further comprises a clearing module; the clearing module comprises a second thin film transistor, a third thin film transistor, and a twelfth thin film transistor;
a control end of the second thin film transistor is input a clearing signal, and a first path end and a second path end thereof are respectively connected to a low level and a current stage pull-up control node;
a control end of the third thin film transistor is input a clearing signal, and a first path end and a second path end thereof are respectively connected to a low level and a current stage holding control node; and
a control end of the twelfth thin film transistor is input a clearing signal, and a first path end and a second path end thereof are respectively connected to a low level and a current stage scanning signal line.

16-17. (canceled)

18. A gate driving circuit, characterized in comprising N stages of the gate driving unit circuit according to claim 1, wherein N is an integer greater than 3; and wherein,
when 2≤n≤N−1, the pull-up control node holding module of the gate driving unit circuit of the nth stage is respectively connected to the holding control node generation module of the gate driving unit circuit of the (n−1)th stage and the holding control node generation module of the gate driving unit circuit of the (n+1)th stage;
when n=1, the pull-up control node holding module of the gate driving unit circuit of the nth stage is input the last-stage clock signal, and is connected to the holding control node generation module of the gate driving unit circuit of the (n+1)th stage;
when n=N, the pull-up control node holding module of the gate driving unit circuit of the nth stage is input the first-stage clock signal, and is connected to the holding control node generation module of the gate driving unit circuit of the (n−1)th stage.

19. A display apparatus, comprising the gate driving circuit according to claim 16.
